(19) United States
(12) Patent Application Publication
(10) Pub. No.: US 2011/0079346 A1
(43) Pub. Date: Apr. 7, 2011

(54) Water based bonding compound and method

(76) Inventor: Barbara Strickland, Litchfield, NH (US)

(21) Appl. No.: 12/587,303

(22) Filed: Oct. 5, 2009

(51) Int. Cl. B32B 37/12; C08L 75/04

(52) U.S. Cl. 156/192; 525/123; 525/124

(57) ABSTRACT

A water based adhesive or bonding agent, which exhibits highly favorable bonding traits, in conjunction with superior material handling aspects. Additionally, the water based adhesive agent endeavors to find use where the handling of solvent based adhesives becomes a hazard. Further, a method for preparation of the water based adhesive agent and a method for usage of the water based bonding system within the shoe manufacturing industry.

### BACKGROUND OF THE INVENTION

1. Field of the Invention

The present invention relates generally to a water based bonding system which yields as effective bonds as solvent-based systems, and method for usage thereof within numerous manufacturing industries, and particularly, to a method for utilizing a fully water-based system for bonding or fusing components in the shoe manufacturing industry.

2. Description of the Related Art

In the manufacture of footwear, several steps in the process require that surfaces be bound together by adhesives. Once the surfaces are adhered they may or may not be stitched depending upon the specific footwear construction. Typically, solvent-based adhesives are used for the adhesive applications. The surfaces that are adhered together are often conditioned such as by washing, roughening, etc. in order to ensure a good adhesive bond.

Certain genres of athletic shoes are manufactured from natural or synthetic uppers, which are respectively, in some manner, bonded to EVA midsoles and rubber outsoles. EVA, or Ethylene-vinyl acetate, is a polymer which qualifies as an ideal material for the production of shoes, because it will not crack under stress. Additionally, certain genres of athletic shoes are manufactured in the older style of canvas, leather, or synthetic uppers with a rubber sole. In such models, the upper is held in place by a vulcanized rubber foxing strip, positioned around the perimeter.

The attached foxing strip may also comprise a rubber toe cap and/or a heel label. While natural rubber (SBR), in either latex dispersions or solvent-based solutions, has long been used for canvas uppers, it has been found to be extremely difficult to achieve bonding of the latex versions to leathers and synthetic uppers. Additionally, and of highest import, these latex dispersions or solvent based solutions may become toxic to both handlers and assembly personnel alike.

Articles designed to compensate for problematic bonding have been known to utilize merely canvas or natural materials for the uppers. An additional solution utilized reveals priming the leather or synthetic with a solvent-based primer. Another common solution is the utilization of a solvent-based rubber cement as the solvents present in the primer or rubber cement allows for better penetration, resulting in strong adhesion.

To address these attempts to, among other things, rectify the inherent problems encountered when working with toxic adhesives, some designers have chosen to work only with canvas. However, this action limits the choices of the designer, which is unacceptable in today's highly competitive footwear market. Thus, while using a solvent-based adhesive is a poor choice environmentally and has been shown to cause health concerns among factory personnel, solvent-based adhesives are still readily utilized in the footwear industry, among other industries.

### SUMMARY OF THE INVENTION

The instant invention, as described further herein, imparts a novel, water based adhesive compound or bonding agent, and accompanying method of deriving said compound and employing said compound, wherein said compound exhibits exemplary bonding characteristics, while maintaining equally exemplary ecological safety standards for personnel utilizing the compound. The instant system as illustrated herein, is neither anticipated, nor rendered obvious or present in any of the prior art methods, neither alone nor in any combination thereof.

The water based bonding system and method for usage thereof within numerous manufacturing industries, and particularly, to a method for utilizing a fully water-based system for bonding components in the shoe manufacturing industry, including types of uppers to these natural rubber soles, toe caps, labels, and foxing strips, that yields as effective bonds as solvent-based systems.

An additional object of the instant system is to provide an adhesive compound which exhibits superior bonding characteristics, while remaining literally non-toxic to the user and consumer alike. An additional object of the instant invention is to provide an water based adhesive to be utilized primarily, but not limited to, the shoe assembly industry

In practice, the process involves commencing with a standard natural latex compounded to cure under standard vulcanizing conditions of 75 minutes at 130° C. This gave us adequate adhesion to canvas and to the uncured rubber sole and foxing prior to vulcanization. Adding 5-30% of a polyurethane dispersion to the latex, with an appropriate amount of blocked isocyanate cure allowed us to get superior bonds to most leather and synthetic uppers. In some extreme cases a primer was necessary; this was a thinner version of the natural latex with greater than 80% polyurethane dispersion and isocyanate curative added.

Continuing, adhesive, and/or primer, is applied by brushing or dipping to the upper in the toe cap area, on the bottom and along the sides (up to approximately ⅓″). The adhesive is then allowed to dry. Simultaneously, adhesive is applied to the back of the uncured rubber toe cap, the foxing strip, and the top of the uncured rubber sole. The second application of adhesive is allowed. The upper and sole are heated to 40° C. and pressed together. The toe cap is positioned on the warm upper and one or two foxing strips are tightly wound around entire perimeter of upper/toe cap/sole unit. If required, a pre-cemented uncured rubber heel label is attached to the outside of the foxing strip at the heel. The completed unit may then be vulcanized for 60-120 minutes at 115-140° C. Under these time/temperature conditions the adhesive, sole, toe cap, heel label, and foxing cure together to give rubber tearing bonds.

While use of a PUD (polyurethane dispersion) to enhance adhesion to difficult surfaces may be known in the art, this method limits the use of both adhesives and substrates. Since the foxing, sole and other attached parts are made of natural rubber, the commonly known adhesive to bond them is also made of natural rubber. Under normal circumstances, PUD's and natural rubbers do not bond well in their original state. A polarizing primer (such as chlorination) is required to treat the natural rubber so it will accept the PUD and careful compounding of the natural latex foxing adhesive creates good compatibility between the two components. The latex portion has an internal mechanism which allows for to curing during vulcanization and thus a blocked isocyanate may be added in order to cure the PUD portion of the adhesive.

Vulcanization refers to a specific curing process of rubber involving high heat and the addition of sulfur or other equivalent curatives and thus comprises a chemical process in which polymer molecules are linked to other polymer molecules by atomic bridges composed of sulfur atoms or carbon to carbon bonds. The end result of vulcanization can best be described as creating springy rubber molecules which become cross-linked to a greater or lesser extent. This structure allows for hardening of the bulk material, along with greater durability and resistance to chemical attack. Vulcanization also renders the surface of the material smoother and prevents the material from sticking to metal or plastic chemical catalysts. In addition, vulcanization possesses a wider time/temperature range than conventional systems (i.e., 60-120 minutes at 115-140° C., vs. standard of 70 minutes at 130° C.).

Additionally as PUD's and natural latex are normally incompatible, this effort reflects great strides and unforeseen results for the industry. PUD's are polar in nature, and normally in the pH range of 5-10. Natural rubber latex is non-polar and stable in a pH range of 10-12. The addition of an acrylic resin dispersion to the natural latex stabilizes the pH as low as 9.0. The acrylic resin additionally buffers the PUD to allow it to remain stable while mixed.

Thus, illustrated is a completely water-based adhesive system for vulcanizing, which is not confined to being mixed in the customer's factory. In addition to the water based advantages inherent in the instant system, an advantage can be derived from the complete upon delivery nature of the compound, which mandates that the instant system requires no in factory mixing. Thus, said system clearly vitiates the possibility of the factory failing to add components, or even failing to add correct amounts of certain components. Moreover, the instant system is compatible with uncured rubber, whether foxing strips, soles, or toe caps, as well as uncured natural latex adhesives. Also, if a primer is necessary, the primer can be mixed on-site and no solvent or solvent-based adhesives or primers are required.

Although converting from solvent to water systems often means longer dry times and/or more handling, this has not been the case. Comparative testing illustrates that an equal amount, or even less, handling and drying are required when utilizing the instant system when compared to conventional solvent based systems.

There has thus been outlined, rather broadly, the many of more important features of the water based bonding compound and method in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates a side view of a shoe illustrating the areas wherein application of adhesive to the upper occurs for both sides of a shoe under manufacturing; and,

FIG. 2 illustrates a side view of a shoe, further displaying the toe cap and two horizontally disposed foxing strips and a heel label attached to the lower foxing strip for both sides of a shoe under manufacturing.

### DETAILED DESCRIPTION OF THE PREFERRED EMBODIMENTS

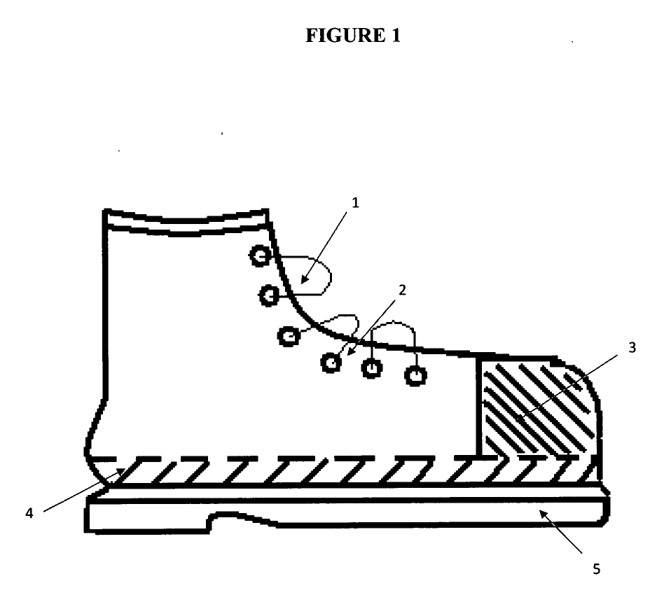

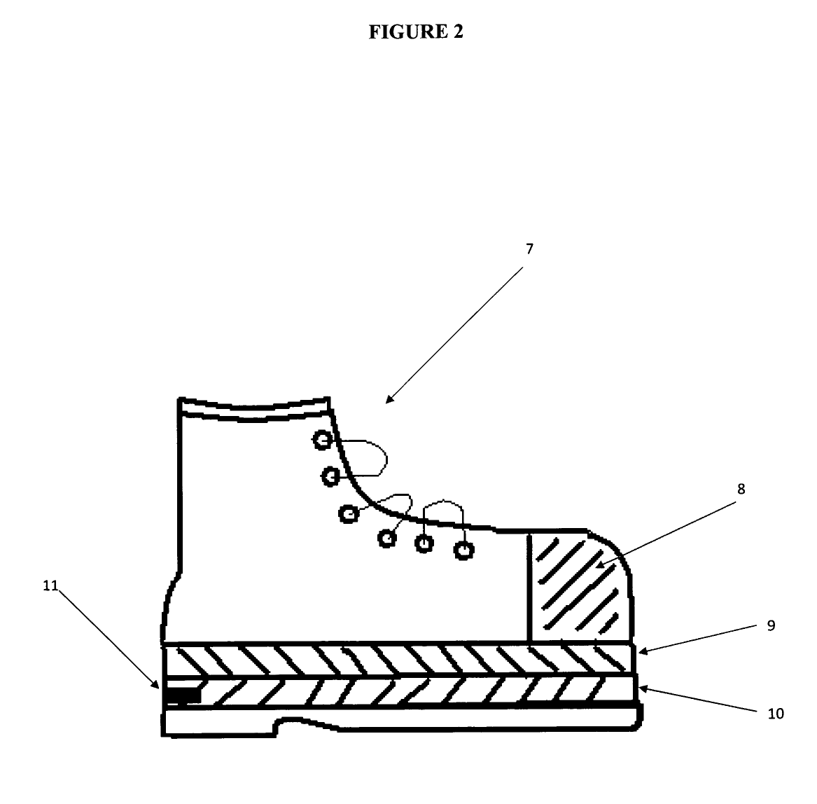

Referring to the Figures, FIG. 1 illustrates a side view of a shoe 1 in a phase of manufacture, illustrating the upper 2, the areas wherein application of the first portion of adhesive 3 and the second portion of adhesive 4 to the upper 2 and the first occurs. Further illustrated is the uncured rubber sole 5. FIG. 2 illustrates a side view of a shoe 7 within a further phase of manufacture, further displaying the toe cap 8 and two horizontally disposed foxing strips, an upper foxing strip 9 and lower foxing strip 10 and a heel label 11 attached to the lower foxing strip 10.

Herein illustrated, a bonding agent which comprises a standard natural latex, compounded to cure under standard vulcanizing conditions of 75 minutes at 130° C., and further comprising a polyurethane dispersion. The polyurethane dispersion may comprise a polyurethane dispersion in a range of five to thirty percent and may comprise a blocked isocyanate cure. The bonding agent may further comprise a primer with a greater than eighty percent 80% polyurethane dispersion and isocyanate curative added. The bonding agent may further comprise an acrylic, resin dispersion. The natural latex may comprise a 9.0 pH and the bond values may increased from an average of 1.3 kgs/cm to 4.6 kgs/cm on synthetic uppers.

Further illustrated herein is a method of preparing a solution for bonding components of athletic shoes the comprising the steps of utilizing a standard natural latex compounded, curing said standard natural latex compound under standard vulcanizing conditions of 75 minutes at 130° C., adding between 5 percent and 30 percent of a polyurethane dispersion to said standard natural latex compound and curing with a blocked isocyanate cure.

Additionally, the step of curing the standard natural latex compound under standard vulcanizing conditions may occurs for a period of 75 minutes at 130° C. Such parameters will provide adequate adhesion to canvas and to the uncured rubber sole and foxing prior to vulcanization. The step of curing with a blocked isocyanate cure will provide superior bonds to most leather and synthetic uppers as well. Within the instant method of preparing a solution for bonding components of athletic shoes, in some extreme cases a primer may be necessary and this is prevalent where there exists a thinner version of the natural latex with less than 80% polyurethane dispersion and isocyanate curative added.

Additionally, a method of utilizing the above discussed solution for bonding components of athletic shoes is illustrated, wherein the athletic shoe comprises the components an upper 2, a sole 5, an uncured rubber toe cap area 8 and a foxing strip 10. The method comprises the step of applying a first portion of adhesive 3 and a second portion of adhesive 4 to an upper 2 toe cap area 10, an upper bottom portion 11 and along the upper side portions 12, up to approximately one third of an inch from a base of said of upper.

The next steps entail allowing the first portion of adhesive to dry, applying a second portion of adhesive to a back area of an uncured rubber toe cap, a foxing strip, and a top area of said uncured rubber sole simultaneously to said step of applying adhesive to said upper in said toe cap area of said shoe, and allowing the second portion of adhesive to dry. Subsequently, the process includes heating said upper and said sole to forty degrees Celsius, pressing said upper and said sole together, placing said toe cap on said warm upper, said upper being disposed in a warmed state, winding at least one foxing strip around an entirety of a perimeter of said upper, said toe cap and said sole to form a shoe unit, and vulcanizing said shoe unit.

In addition a pre-cemented, uncured rubber heel label may be attached to the outside of the foxing strip at said the heel prior to vulcanization in order to permanently affix said rubber heel label to said shoe unit. A primer may be applied prior to applying first portion of adhesive to the upper in a toe cap area of a shoe and two foxing strips may be utilized. The step of vulcanizing said shoe unit is best accomplished within a time range between sixty minutes and one hundred and twenty minutes at a temperature range between one hundred and fifteen degrees Celsius and one hundred and forty degrees Celsius in order to create rubber tearing bonds.

What is claimed is:

1. A bonding agent comprising:
a standard natural latex compounded to cure under standard vulcanizing conditions of 75 minutes at 130° C.; and,
a polyurethane dispersion.

2. The bonding agent of claim 1 wherein said polyurethane dispersion comprises a polyurethane dispersion in a range of five to thirty percent.

3. The bonding agent of claim 1 wherein said polyurethane dispersion comprises a blocked isocyanate cure.

4. The bonding agent of claim 1 wherein said bonding agent further comprising a primer with a greater than eighty percent 80% polyurethane dispersion and isocyanate curative added.

5. The bonding agent of claim 4 wherein said a primer further comprises a composition of polyurethane dispersion and rubber.

6. The bonding agent of claim 1 further comprising an acrylic resin dispersion.

7. The bonding agent of claim 1 further wherein said natural latex comprises a 9.0 pH.

8. The bonding agent of claim 1 wherein bond values increased from an average of 1.3 kgs/cm to 4.6 kgs/cm on synthetic uppers.

9. A method of preparing a solution for bonding components of athletic shoes the comprising the steps of:
utilizing a standard natural latex compounded;
curing said standard natural latex compound under standard vulcanizing conditions of 75 minutes at 130° C.;
adding between 5 percent and 30 percent of a polyurethane dispersion to said standard natural latex compound; and,
curing with a blocked isocyanate cure.

10. The method of preparing a solution for bonding components of athletic shoes of claim 9 wherein said step of curing said standard natural latex compound under standard vulcanizing conditions for a period seventy five minutes at one hundred and thirty degrees Celsius.

11. The method of preparing a solution for bonding components of athletic shoes of claim 9 wherein said step of curing with a blocked isocyanate cure provides superior bonds to leather and synthetic uppers.

12. The method of preparing a solution for bonding components of athletic shoes of claim 9 wherein further comprising utilization of a primer.

13. The method of preparing a solution for bonding components of athletic shoes of claim 12 further comprising a greater than eighty percent polyurethane dispersion and an isocyanate curative added.

14. A method of utilizing said solution for bonding components of athletic shoes of claim 9, wherein said components comprise an upper, a sole, an uncured rubber toe cap area, a foxing strip, comprising the steps of:
applying a first portion of adhesive to an upper toe cap area, an upper bottom portion and along the upper side portions, up to approximately one third of an inch from a base of said of upper;
allowing said first portion of adhesive to dry;
applying a second portion of adhesive to a back area of an uncured rubber toe cap, a foxing strip, and a top area of said uncured rubber sole simultaneously to said step of applying adhesive to said upper in said toe cap area of said shoe;
allowing said second portion of adhesive to dry;
heating said upper and said sole to forty degrees Celsius;
pressing said upper and said sole together;
placing said toe cap on said warm upper, said upper being disposed in a warmed state;
winding at least one foxing strip around an entirety of a perimeter of said upper, said toe cap and said sole to form a shoe unit; and,
vulcanizing said shoe unit.

15. The method of utilizing said solution for bonding components of athletic shoes of claim 14 wherein a pre-cemented, uncured rubber heel label is attached to the outside of the foxing strip at said the heel prior to vulcanization.

16. The method of utilizing said solution for bonding components of athletic shoes of claim 13 wherein a primer is applied to said upper in a toe cap area of a shoe, prior to applying first portion of adhesive to said upper in a toe cap area of a shoe.

17. The method of utilizing said solution for bonding components of athletic shoes of claim 13 wherein said at least foxing strip comprises two foxing strips.

18. The method of utilizing said solution for bonding components of athletic shoes of claim 13 wherein said step of vulcanizing said shoe unit is accomplished within a time range between sixty minutes and one hundred and twenty minutes.

19. The method of utilizing said solution for bonding components of athletic shoes of claim 18 wherein said step of vulcanizing said shoe unit comprises a temperature range between one hundred and fifteen degrees Celsius and one hundred and forty degrees Celsius and creates rubber tearing bonds.
